(19) United States
(12) Patent Application Publication
(10) Pub. No.: US 2025/0089682 A1
(43) Pub. Date: Mar. 20, 2025

(54) DEVICES AND METHODS FOR COUPLING ACCESSORIES TO COLLARS

(71) Applicant: Mars, Incorporated, McLean, VA (US)

(72) Inventors: Russ SMITH, San Francisco, CA (US); Borna DEHGHANI, Richmond, CA (US); Nicholas KINLOCH, San Francisco, CA (US)

(21) Appl. No.: 18/884,385

(22) Filed: Sep. 13, 2024

Related U.S. Application Data
(60) Provisional application No. 63/583,077, filed on Sep. 15, 2023.

(51) Int. Cl. A01K 27/00

(52) U.S. Cl. CPC A01K 27/008; A01K 27/001

(57) ABSTRACT

A base has a body defining a connecting wall having a first end and a second end. The body also defines a first arm extending from the first end of the connecting wall, the first arm including a first surface and a first protrusion extending from the first surface, and a second arm extending from the second end of the connecting wall, the second arm including a second surface and a second protrusion extending from the second surface toward the first arm. The second protrusion overlaps with the first protrusion to retain a collar received in a through-slot defined by the connecting wall, the first and second surfaces, and the first and second protrusions. The body further defines a first interface extending from the first arm opposite a side of the first arm including the first surface, where the first interface is configured to couple a housing to the base.

### CROSS-REFERENCE TO RELATED APPLICATION(S)

This patent application is a continuation of and claims the benefit of priority to U.S. Application No. 63/583,077, filed on Sep. 15, 2023, the entirety of which is incorporated herein by reference.

### TECHNICAL FIELD

This disclosure relates generally to devices and methods for coupling accessories to collars or other strap-like objects worn or carried by pets.

### BACKGROUND

Pet owners are generally interested in pet accessories (e.g., health trackers, location trackers, identification holders, treat holders, signal/sound generators, etc.) that may provide information about their pets, make some aspect of pet ownership easier or safer, and/or may improve the lives of their pets. Many of these accessories come in the form of devices or objects that have some type of structure, may be intended to move along with or remain in proximity of pets, and require mechanisms (e.g., cases, housings, attachment mechanisms, etc.) to ensure they do, in fact, move with the pet by attaching the accessories to a collar of the pet, for example. Current solutions are generic, cumbersome, unreliable, lack versatility, and are not specifically tailored towards certain pet owner needs or specific accessories that address pet owner needs. As a result, current solutions do not effectively allow pet owners to securely, safely, compactly, and/or reliably append even one, let alone multiple, useful accessories to collars or other-strap like objects worn or carried by their pets.

This disclosure is directed to addressing above-referenced challenges. The background description provided herein is for the purpose of generally presenting the context of the disclosure. Unless otherwise indicated herein, the materials described in this section are not admitted to be prior art, or suggestions of the prior art, by inclusion in this section.

### SUMMARY OF THE DISCLOSURE

In some aspects, bases are disclosed. An example base has a body defining a connecting wall having a first end and a second end. The body also defines a first arm extending from the first end of the connecting wall, the first arm including a first surface and a first protrusion extending from the first surface, and a second arm extending from the second end of the connecting wall, the second arm including a second surface and a second protrusion extending from the second surface toward the first arm. The second protrusion overlaps with the first protrusion to retain a collar received in a through-slot defined by the connecting wall, the first and second surfaces, and the first and second protrusions. The body further defines a first interface extending from the first arm opposite a side of the first arm including the first surface, where the first interface is configured to couple a housing to the base.

In other aspects, cases are disclosed. An example case includes a base having a body that defines: a connecting wall having a first end and a second end; a first arm extending from the first end of the connecting wall, the first arm including a first surface and a first protrusion extending from the first surface; a second arm extending from the second end of the connecting wall, the second arm including a second surface and a second protrusion extending from the second surface toward the first arm such that a through-slot for receiving a collar is defined by the connecting wall, the first and second surfaces, and the first and second protrusions; a protruding wall extending from the first arm opposite a side of the first arm including the first surface; and a lip extending outwardly from the protruding wall. The examples case also includes a housing coupled to the base, wherein a structure of the housing defines: an outer wall extending from a first end to a second end of the housing; a first lateral wall at the first end of the housing extending inwardly from the outer wall; and an extension wall extending from the first lateral wall toward the second end of the housing and defining a portion of an engagement structure of the housing, wherein the extension wall engages with the protruding wall and the lip of the base to couple the housing to the base.

In further aspects, cases are disclosed. An example case includes a base having a body that defines: a connecting wall having a first end and a second end; a first arm extending from the first end of the connecting wall, the first arm including a first surface and at least one first protrusion extending from the first surface; a second arm extending from the second end of the connecting wall, the second arm including a second surface and at least one second protrusion extending from the second surface toward the first arm such that a through-slot for receiving a collar is defined by the connecting wall, the first and second surfaces, and the first and second protrusions; a first interface extending from the first arm opposite a side of the first arm including the first surface; and a second interface extending from the second arm opposite a side of the second arm including the second surface. The example case also includes a first housing coupled to the base via the first interface and configured to receive a first accessory. The example case further includes a second housing coupled to the base via the second interface and configured to receive a second accessory different than the first accessory.

It is to be understood that both the foregoing general description and the following detailed description are exemplary and explanatory only and are not restrictive of the disclosed examples.

### BRIEF DESCRIPTION OF THE DRAWINGS

The accompanying drawings, which are incorporated in and constitute a part of this specification, illustrate various exemplary examples and together with the description, serve to explain the principles of the disclosed examples.

FIG. 1A depicts a first perspective view of a case, according to an aspect of the present disclosure.

FIG. 1B depicts a second perspective view of the case of FIG. 1A.

FIG. 1C depicts an exploded view of the case of FIG. 1A in an orientation corresponding to an orientation of the case as depicted in FIG. 1A.

FIG. 1D depicts an exploded view of the case of FIG. 1A in an orientation corresponding to an orientation of the case as depicted in FIG. 1B.

FIG. 2A depicts a front or rear elevation view of a base, according to an aspect of the present disclosure.

FIG. 2B depicts a bottom elevation view of the base of FIG. 2A, looking in a direction 2B from a plane corresponding to line 2B-2B of FIG. 2A.

FIG. 2C depicts a side elevation view of the base of FIG. 2A, looking in a direction 2C from a plane corresponding to line 2C-2C of FIG. 2B.

FIG. 2D depicts a top elevation view of the base of FIG. 2A, looking in a direction 2D from a plane corresponding to line 2D-2D of FIG. 2C.

FIG. 2E depicts a front or rear elevation view of the base of FIG. 2A, looking in a direction 2E from a plane corresponding to line 2E-2E of FIG. 2D.

FIG. 3A depicts a front or rear elevation view of a case, according to an aspect of the present disclosure.

FIG. 3B depicts a cross-sectional view the case of FIG. 3A, looking in a direction 3B from a plane corresponding to line 3B-3B of FIG. 3A.

FIG. 3C is an enlarged view of a portion of FIG. 3B depicting an example engagement between a base and a second housing of the case of FIG. 3A.

FIG. 3D is an enlarged view of a portion of FIG. 3B depicting an example relative arrangement of protrusions of the base of FIG. 3B.

FIG. 3E is an enlarged view of a portion of FIG. 3B depicting an example engagement between the base and a first housing of the case of FIG. 3A.

FIG. 3F depicts a cross-sectional view the case of FIG. 3A, looking in a direction 3E from a plane corresponding to line 3F-3F of FIG. 3A.

FIG. 4A depicts a front or rear elevation view of a case, according to an aspect of the present disclosure.

FIG. 4B depicts a cross-sectional view the case of FIG. 4A, looking in a direction 4B from a plane corresponding to line 4B-4B of FIG. 4A.

FIG. 4C is an enlarged view of a portion of FIG. 4B depicting one example engagement between a base and a first housing of the case of FIG. 4A.

FIG. 4D is an enlarged view of a portion of FIG. 4B depicting another example engagement between the base and the first housing of the case of FIG. 4A.

FIG. 5 depicts a side perspective view of a case, according to an aspect of the present disclosure.

FIGS. 6A and 6B depict front and side perspective views of a base, according to an aspect of the present disclosure.

FIG. 7 depicts a side perspective view of a case, according to an aspect of the present disclosure.

FIGS. 8A and 8B depict front and side perspective views of a base, according to an aspect of the present disclosure.

FIGS. 9A-9F depict front, rear, left side, right side, top, and bottom elevated views of the case of FIG. 1A, according to an aspect of the present disclosure.

FIGS. 9G and 9H depict front and rear perspective views of the case of FIG. 1A, according to an aspect of the present disclosure.

### DETAILED DESCRIPTION

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

As used herein, a term such as “user” or “individual” or the like generally encompasses a pet owner or any other individual interacting with a pet, such as a care provider of the pet, to place a collar on the pet, among other examples.

A term such as “pet” or the like generally encompasses a domestic animal, such as a domestic canine, feline, rabbit, ferret, horse, cow, or the like. In various examples according to the present disclosure, “pet” may refer to a canine.

As used herein, a term such as “collar” or the like generally encompasses any type of strap or other material that may be worn or carried and is not intended to limit aspects of the disclosure. In various examples according to the present disclosure, “collar” may refer to a collar of a pet.

A term such as “accessory” or the like generally encompasses a device, a toy, a bell/sound maker, a tag, a pet care product such as a flee repellant, a case, a container or the like for pet food or medicine (e.g., a pill bottle), or other items having a structure. In various examples according to the present disclosure, “device” may refer to a portable electronic component such as a location tracker (e.g., GPS tracker), activity or health monitor, alert, light, sensor, or the like. In other examples according to the present disclosure, “device” may refer to a component that may be powered by replaceable or rechargeable batteries.

Accessory functionalities may rely on the accessory being within at least a certain proximity to the pet. Therefore, due to mobility of pets, the accessories are often mechanically attached to a pet's collar via a mechanism, such as a clip, a clasp, a mount, or other similar mechanism to ensure such proximity. In some examples, the accessories may also be secured within a case or other similar housing to which the mechanism is coupled to enable the housing of the accessory to be attached to the pet's collar. However, conventional accessories, associated housings, and/or attachment mechanisms may be vulnerable to detachment or uncoupling, particularly when the pet is highly active or mobile. Specifically, the accessories may become unsecured or loose from the housing and/or detached from the mechanisms that are attaching the accessories to the pet's collar. Additionally or alternatively, the mechanisms attaching the accessories and/or the housings to the pet collar may become detached from the pet collar, which necessarily causes the accessories to also be detached. When the accessories becomes detached, the accessories may no longer remain within a proximity to the pet, and thus the functionalities of the accessories are rendered ineffective or useless. For example, if the accessory is a location tracker attached to a pet's collar for tracking a current location of a pet, and the accessory becomes detached from the pet's collar, the location tracker is no longer able to provide the current location of the pet.

The aspects disclosed herein provide solutions to the detachment or uncoupling vulnerabilities of conventional accessories, associated housings, and/or attachment mechanisms. For example, in one aspect, a case may include a base and one or more housings. Each of the housings may be configured to receive an accessory to removably couple the accessory to the base. The housings may be configured to secure the accessory within the housing when received, while also enabling ease of removal from the housing (e.g., to charge, interchange, and/or replace the accessory). Additionally, a body of the base defines one or more interfaces for securely coupling the corresponding housings to the base to prevent the housings, and thus any accessories received and secured by the housings, from detaching from the base. Further, the body of the base is configured to receive and retain a collar to prevent the case from detaching from the collar.

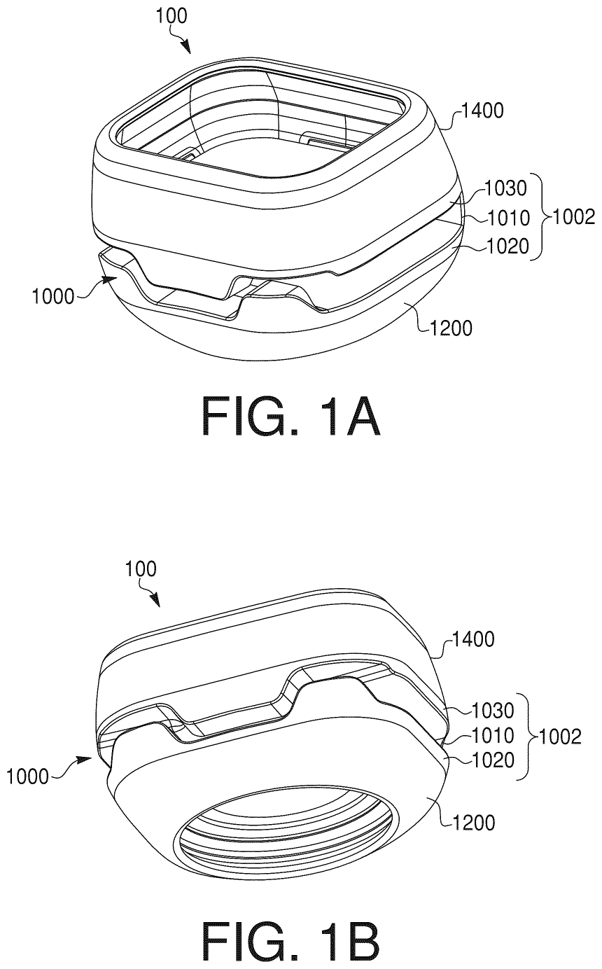

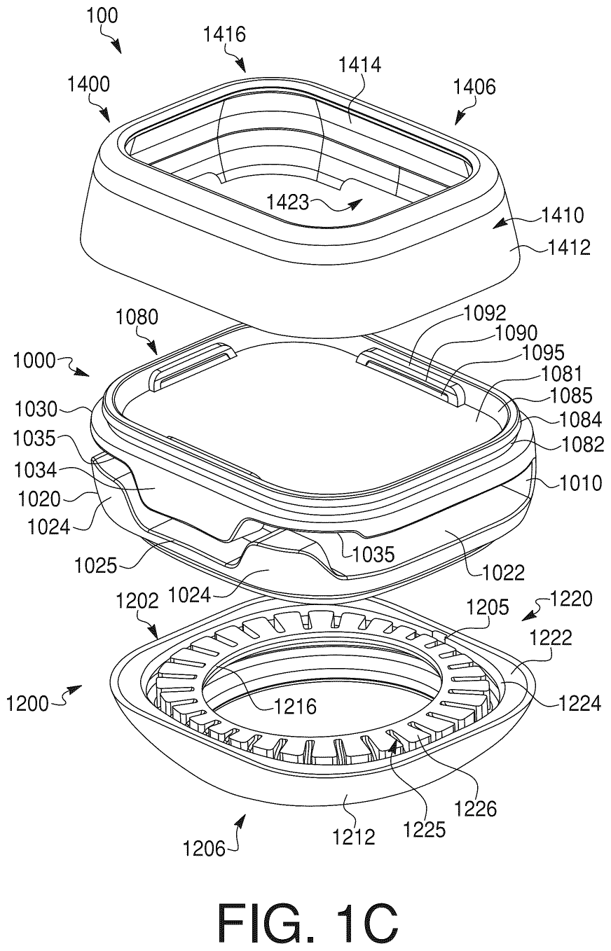

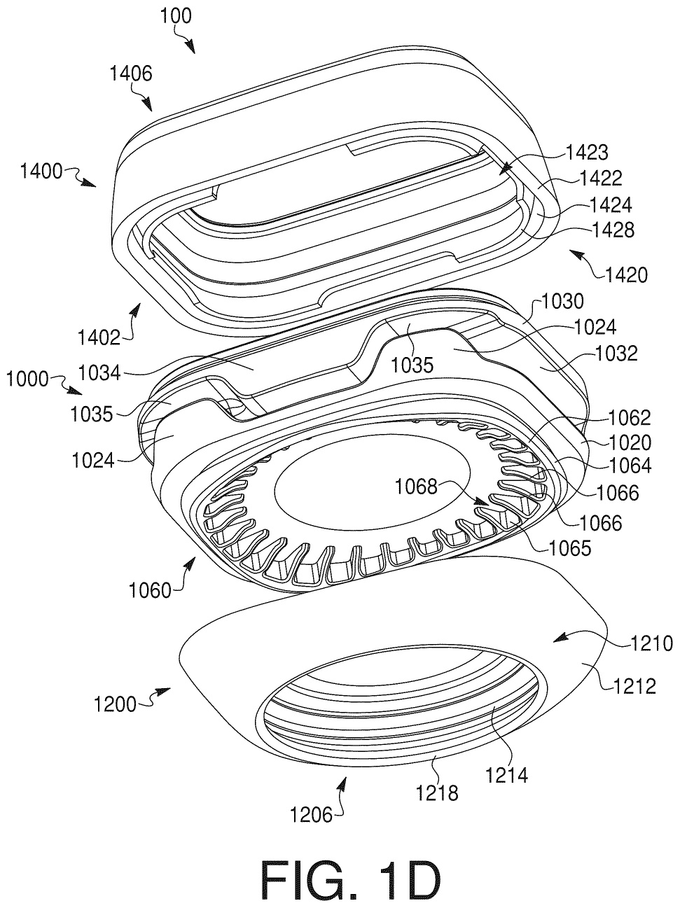

FIG. 1A depicts a first perspective view of a case 100, according to an aspect of the present disclosure, and FIG. 1B depicts a second perspective view of the case of FIG. 1A. In one example, the case 100 may include a base 1000, a first housing 1200, and a second housing 1400. According to aspects of the present disclosure, the base 1000 may be configured to secure the case 100 to another object, such as a collar for a pet. In some examples, the base 1000 may secure the case 100 to the collar such that the second housing 1400 faces toward and/or contacts the pet when the collar is worn by the pet. In other examples, the base 1000 may secure the case 100 to the collar such that the first housing 1200 faces toward and/or contacts the pet when the collar is worn by the pet. Additionally, each of the first housing 1200 and the second housing 1400 may be configured to receive and secure a device, mechanism, or object of some type (hereafter referred to as “an accessory”) to the base 1000. As a result, the case 100 may provide a carrier or holder configured to (detachably) couple one or more accessories to another object, such as the collar for the pet. Resultantly, the case 100 and the collar may be used together to ensure one or more accessories remain proximal to the pet when the pet is wearing the collar.

In one example, the base 1000 is comprised of a body 1002 that defines or otherwise includes a connecting wall 1010, a first arm 1020, and a second arm 1030. For example, the connecting wall 1010 may have a first end and a second end opposite the first end. The first arm 1020 may extend (e.g., perpendicularly) from the first end of the connecting wall 1010 in a first direction. The second arm 1030 may extend (e.g., perpendicularly) from the second end of the connecting wall 1010 in the same first direction.

The body 1002 of the base 1000 may be formed from a generally rigid material. In one example, the base 1000 may be formed from a hard plastic, such as a polycarbonate resin, or other compositions including plastic and/or fiber glass, among other similar examples. According to an aspect of the present disclosure, while the base 1000 may be formed from a rigid material, a configuration thereof may provide a degree of flexibility between the first arm 1020 and the second arm 1030. Such (elastic) flexibility may be useful for coupling the case 100 to an object, such as a collar, by receiving the object between the first arm 1020 and the second arm 1030, which is described in more detail below.

The first housing 1200 and/or the second housing 1400 may be formed from a flexible elastic material, such as silicon, that may allow walls of the first housing 1200 and/or the second housing 1400 to be friction fitted around respective accessories. Additionally, the first housing 1200 and the second housing 1400 may each define structural engagements configured to flex into and/or around corresponding structural interfaces of the base 1000. In other examples, the first housing 1200 and/or the second housing 1400 may be formed from rigid material such that a respective engagement is configured to be coupled to a corresponding structural interface of the base 1000 by way of a different type of engagement, such as a snap fit. In still other examples, one or more of the first housing 1200, the second housing 1400, and the base 1000 may include portions thereof formed by one material and other portions formed from another material that may differ in type and material properties.

As discussed with more particularity below, a configuration of the base 1000 of the case 100 enables simple (yet secure) coupling and removal of the case 100 to and from other objects, such as a collar. Additionally, various types of different accessories may be removeably coupled to the base 1000 by the first housing 1200 and the second housing 1400. For example, walls of each of the first housing 1200 and the second housing 1400 may be configured to surround and secure an accessory in a substantially (friction) fitted manner.

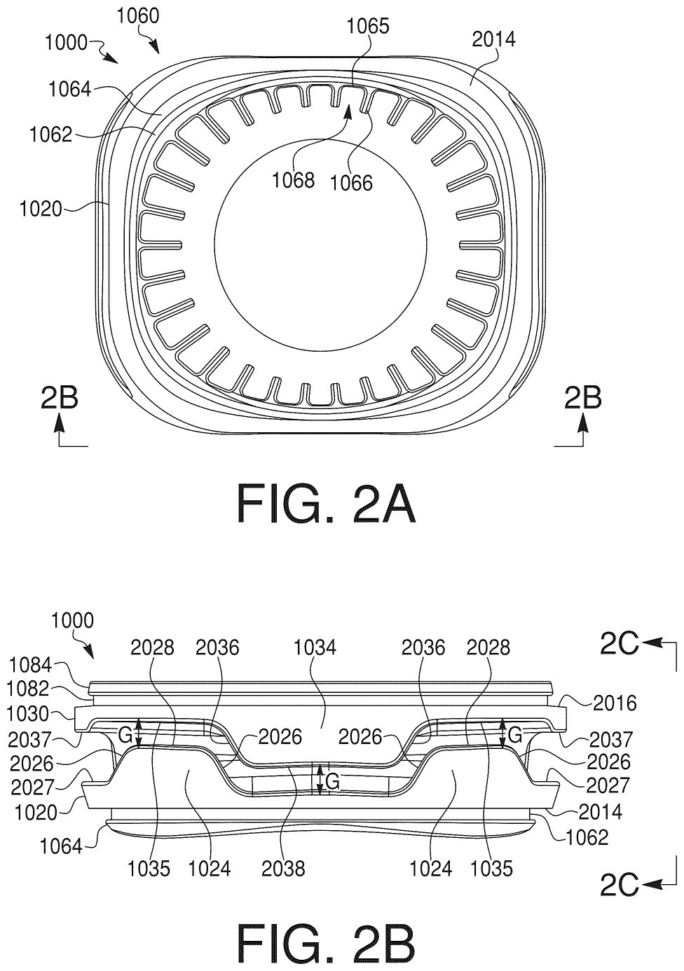

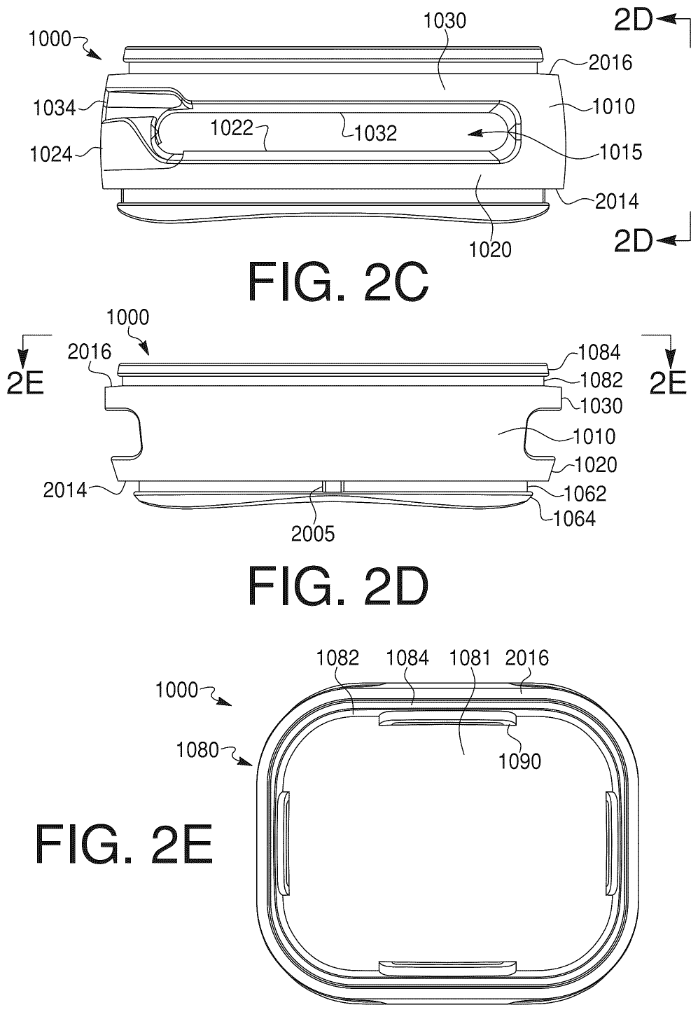

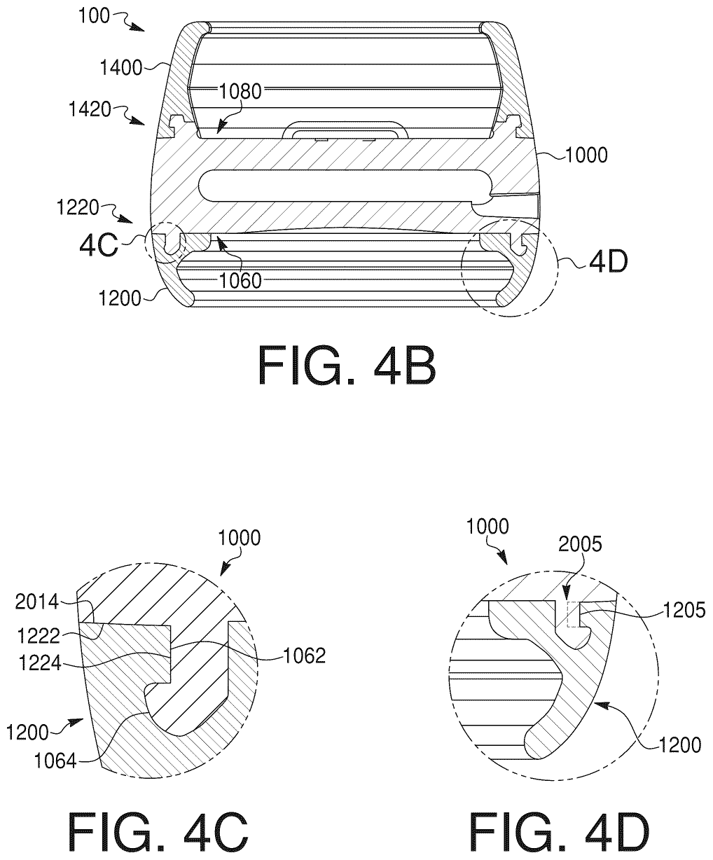

Turning to FIG. 1C, an exploded view of the case 100 of FIG. 1A is depicted in an orientation corresponding to an orientation of the case 100 as depicted in FIG. 1A. FIG. 1C provides a perspective view of the first housing 1200 to illustrate a first end 1202 of the first housing 1200. As illustrated in FIG. 1C, a first lateral wall 1222 is provided at the first end 1202 and extends along a perimeter of the first end 1202. A first extension wall 1224 extends from an inner edge of the first lateral wall 1222 toward a second end 1206 of the first housing 1200. In one example, the first extension wall 1224 defines a notch 1205 configured to receive a positioning protrusion 2005 (see FIGS. 2D and 4D) defined by the base 1000. The first extension wall 1224 and the notch 1205 define an outer portion of a first engagement structure 1220 of the first housing 1200.

As illustrated in FIG. 1C, the first engagement structure 1220 also includes a second lateral wall 1226. As shown in FIG. 1C, an inner edge of the second lateral wall 1226 defines a first aperture 1216 of the first housing 1200. Additionally, the second lateral wall 1226 defines a plurality of engagement slots 1225 arranged circumferentially and extending a portion of a length of the second lateral wall 1226.

FIG. 1D depicts an exploded view of the case 100 of FIG. 1A in an orientation corresponding to an orientation of the case 100 as depicted in FIG. 1B. FIG. 1D illustrates a first interface 1060 defined by the base 1000 that is configured to receive the first engagement structure 1220 of the first housing shown in FIG. 1C. For example, the first interface 1060 may include a first protruding wall 1062 and a first lip 1064. A plurality of ribs 1066 may extend inwardly from the first protruding wall 1062. Referring concurrently to FIGS. 1C and 1D, the engagement slots 1225 of the first housing 1200 may be configured to receive the ribs 1066 defined by the base 1000. For example, the ribs 1066 may be distributed about a first base inner surface 1065 of the first protruding wall 1062 so as to define receivers 1068 to accommodate portions of the second lateral wall 1226 between the engagement slots 1225 received by the ribs 1066. The engagement slots 1225 and the ribs 1066 may be distributed circumferentially relative to the first aperture 1216 of the first housing 1200 and a central portion of the base 1000, respectively.

One of ordinary skill in the art will recognize that the engagement slots 1225 and the ribs 1066 may advantageously enhance a friction fit between the first housing 1200 and the base 1000. This is particularly advantageous when the base 1000 is composed of a rigid first material and the first housing 1200 is formed from a flexibly elastic second material, which impacts adhesion between the two components. For example, the engagement slots 1225 and the ribs 1066 may provide: (1) an interlocking engagement and prevent movement of one component relative to the other; and (2) increase a total surface area of surfaces and sub-components of the first housing 1200 and the base 1000 that are in contact. In some aspects, the first housing 1200 and the base 1000 may be further secured to one another using adhesives. Relative to an implementation not including slots and ribs (e.g., an implementation using only adhesives to secure the components), the increased surface area of contact provided by the ribs 1066 and the engagement slots 1225 further increases the strength of securements incorporating adhesives.

Continuing with reference to FIG. 1D, the perspective view of FIG. 1D further provides an illustration of the second end 1206 of the first housing 1200. The second end 1206 includes a second aperture 1218 defined by a first outer wall 1210 of the first housing 1200. The first outer wall 1210 extends from the first lateral wall 1222 at the first end 1202 (FIG. 1C) in an exemplary converging manner towards the second end 1206 of the first housing 1200.

A first outer surface 1212 of the first outer wall 1210 defines one surface of the case 100. As previously mentioned, in some examples, the base 1000 may secure the case 100 to a collar such that the second housing 1400 faces towards and/or contacts the pet when the collar is worn by the pet. In such examples, the first outer surface 1212 may be a surface of the case 100 that faces away or outwardly from the pet and is most visible to the user. In another example, the base 1000 may secure the case 100 to the collar such that the first housing 1200 faces toward and/or contacts the pet when the collar is worn by the pet. In such examples, the first outer surface 1212 may be a surface of the case 100 that faces toward or inwardly to the pet and is less visible to the user. The first outer surface 1212 may be continuous as shown. In other examples, a plurality of protrusions may extend from, and/or a plurality of dimples may be defined in, the first outer surface 1212. Such a configuration may increase tactile feedback experienced by a user gripping the first housing 1200 of the case 100 including the first housing 1200. The first outer wall 1210 further includes a first housing inner surface 1214. According to an aspect of the present disclosure, generally, the first housing inner surface 1214 may be configured to fit or otherwise correspond with a structure of an accessory to be received by and secured within the case 100 between the first aperture 1216 and the second aperture 1218.

Continuing to refer to FIG. 1D, the perspective view of FIG. 1D further illustrates a first end 1402 of the second housing 1400 that is configured to couple to an opposite side of the base 1000 as the first housing 1200. A third lateral wall 1422 is disposed at the first end 1402 and provides an end face of the second housing 1400. A second extension wall 1424 extends from an inner edge of the third lateral wall 1422 toward a second end 1406 of the second housing 1400.

The second extension wall 1424 defines an outer portion of a second engagement structure 1420 of the second housing 1400. For example, the second engagement structure 1420 includes a third extension wall 1428 disposed inwardly of and surrounded by the second extension wall 1424. In one example, the third extension wall 1428 may define a plurality of elongated recesses 1423. The second engagement structure 1420 may couple the second housing 1400 to the base 1000. Turning back to FIG. 1C, FIG. 1C illustrates a second interface 1080 defined by the base 1000 that is configured to receive the second engagement structure 1420 of the second housing 1400 to couple the second housing 1400 to the base 1000. For example, the second interface 1080 may include a second protruding wall 1082 and a second lip 1084 extending from the second protruding wall 1082. The second protruding wall 1082 may extend from and surround at least a portion of an open surface 1081 of the base 1000. One or more third protrusions 1090 may extend from the open surface 1081 and be disposed inwardly of the second protruding wall 1082.

Referring concurrently to FIGS. 1C and 1D, the elongated recesses 1423 of the second housing 1400 may be configured to correspond to the third protrusions 1090. Along with the second extension wall 1424 and the third extension wall 1428, the second housing 1400 may define or otherwise provide one or more circumferential recesses configured to receive the second protruding wall 1082 and the second lip 1084. In one example, each of the third protrusions 1090 may define an engagement feature 1095 (e.g., space, recess, dimples, slot, etc.) between an outermost edge 1092 of the third protrusion 1090 and the open surface 1081. In some examples, if an accessory to be coupled to the base 1000 via the first housing 1200 includes a protruding structure, the engagement feature 1095 may be defined according to the protruding structure to enhance securement of the accessory within the first housing 1200. In addition, one of ordinary skill in the art will recognize that the third protrusions 1090 of the base 1000 and the elongated recesses 1423 of the second housing 1400 may advantageously enhance a friction fit between the second housing 1400 and the base 1000. This is particularly advantageous when the base 1000 is composed of a rigid first material and the second housing 1400 is formed from a flexibly elastic second material, which impacts adhesion between the two components.

Continuing with the second housing 1400 and turning back to FIG. 1C, the perspective view of FIG. 1C further provides an illustration of the second end 1406 of the second housing 1400. The second end 1406 includes a third aperture 1416 defined by a second outer wall 1410 of second housing 1400. The second outer wall 1410 extends from the third lateral wall 1422 at the first end 1402 of the second housing 1400 (FIG. 1D) in an exemplary converging manner towards the second end 1406 of the second housing 1400. A second outer surface 1412 of the second outer wall 1410 may be continuous as shown. In other examples, a plurality of protrusions may extend from, and/or a plurality of dimples may be defined in, the second outer surface 1412. Such a configuration may increase tactile feedback experienced by an individual gripping the second housing 1400 of the case 100. The second outer wall 1410 further includes a second housing inner surface 1414. According to an aspect of the present disclosure, generally, the second housing inner surface 1414 may be configured to fit or otherwise correspond with a structure of an accessory to be coupled to the case 100 by the second housing 1400. The accessory to be coupled to the case 100 by the second housing 1400 may be a different accessory in type and/or structure from the accessory to be coupled to the case 100 by the first housing 1200.

Turning to the base 1000, as illustrated in FIG. 1C, the first arm 1020 and the second arm 1030 extend from the connecting wall 1010 along planes perpendicular to a plane of the connecting wall 1010. In one example, the first arm 1020 may include a first arm surface 1022 and a pair of first protrusions 1024 extending at an angle from a side of the first arm surface 1022 opposite a side that is adjacent to the connecting wall 1010. A first recess 1025 may be defined between the pair of first protrusions 1024 and configured to at least partially receive a second protrusion 1034 extending from the second arm 1030 toward the first arm 1020. For example, the second protrusion 1034 may be staggered or offset from the pair of first protrusions 1024 such that the first recess 1025 is configured to partially receive the second protrusion 1034.

Continuing with FIG. 1C, the second interface 1080 of the base 1000 extends from the second arm 1030 opposite a side from which the second protrusion 1034 extends. As previously mentioned, the second interface 1080 may include the second protruding wall 1082, the second lip 1084, and the third protrusions 1090. These and other components of the second interface 1080 may be configured to substantially correspond with the second engagement structure 1420 of the second housing 1400. More specifically, components of the second interface 1080 may be configured to receive and be received by corresponding components of the second engagement structure 1420. Engagements between these components may facilitate a friction fit between the base 1000 and the second housing 1400 sufficiently secure to help ensure that the second housing 1400, and thus any accessory received by and positioned within the second housing 1400, remains coupled to the base 1000.

With reference to FIG. 1D, the second arm 1030 may include a second arm surface 1032, where the second protrusion 1034 extends at an angle from a side of the second arm surface 1032 opposite a side that is adjacent to the connecting wall 1010. A second recess 1035 may be defined by the second arm surface 1032 on each side of the second protrusion 1034. The second recesses 1035 may correspond to, and face, the first protrusions 1024 of the first arm 1020.

Continuing with FIG. 1D, a surface of the first arm 1020 opposite of the first arm surface 1022 may include the first interface 1060 of the base 1000. As discussed above, the ribs 1066 may be one component defined by the first interface 1060. In some examples, structural aspects of the first interface 1060 may be configured to substantially correspond with the first engagement structure 1220 of the first housing 1200, shown in FIG. 1C. More specifically, components of the first interface 1060 may be configured to receive and be received by corresponding components of the first engagement structure 1220. Engagements between these components may facilitate a friction fit between the base 1000 and the first housing 1200 sufficiently secure to ensure that the first housing 1200, and thus any accessory received by and positioned within the first housing 1200, remains coupled to the base 1000.

With respect to FIGS. 2A-2E, the various elevation views of the base 1000 (e.g., front, rear, side, top, bottom) may be based on a position or orientation of the base 1000 relative to a collar or other similar object when the base 1000 receives the collar. FIG. 2A depicts a front or rear elevation view of the base 1000, according to an aspect of the present disclosure. In some examples, the base 1000 may secure the case 100 to the collar such that the first housing 1200 faces away and/or outwardly from the pet when the collar is worn by the pet. In such examples, the elevation view of the base 1000 shown in FIG. 2A may be a front elevation view (e.g., with the first housing 1200 removed to illustrate the first interface 1060 of the base 1000). In another example, the base 1000 may secure the case 100 to the collar such that the first housing 1200 faces towards and/or contacts the pet when the collar is worn by the pet. In such examples, the elevation view of the base 1000 shown in FIG. 2A may be a rear elevation view (e.g., with the first housing 1200 removed to illustrate the first interface 1060 of the base 1000).

As shown, the ribs 1066 are distributed about a first base inner surface 1065 of the first protruding wall 1062 so as to define receivers 1068 that may accommodate corresponding flexible structures of the first housing 1200 to couple the first housing 1200 to the base 1000.

FIG. 2B depicts a bottom elevation view of the base 1000 of FIG. 2A, looking in a direction 2B from a plane corresponding to line 2B-2B of FIG. 2A. As shown, each first protrusion 1024 extending from the first arm 1020 may be formed with first angled walls 2026 that extend from the first arm 1020 and are joined by a first planar wall 2028. In addition, the first arm 1020 may define first flanks 2027 outside of the first protrusions 1024. On the second arm 1030, the second protrusion 1034 extending from the second arm 1030 may be formed with second angled walls 2036 that extend from the second recesses 1035 toward the first arm 1020 and are joined by a second planar wall 2038. The second arm 1030 may define second flanks 2037 outside of, and defining outer portions of, the second recesses 1035. Each first protrusion 1024 may extend from the first arm 1020 to the second arm 1030, however each first protrusion 1024 may not contact the second arm 1030. Similarly, the second protrusion 1034 may extend from the second arm 1030 to the first arm 1020, however the second protrusion 1034 may not contact the first arm 1020. Resultantly, a gap (G) remains between the first arm 1020 and the second arm 1030 to enable the base 1000 to receive a collar, for example.

Although the first arm 1020 includes multiple first protrusions 1024 and the second arm 1030 includes one second protrusion 1034, one of ordinary skill in the art will recognize other configurations of the base 1000 may include a single first protrusion 1024 and multiple second protrusions 1034. Furthermore, although the example base 1000 provides for a two first protrusion to one second protrusion ratio, and vice versa, other configurations may include a one to one, or three to two, or two to three arrangements.

FIG. 2B also provides a view of the first lip 1064 which extends outwardly from the first protruding wall 1062. The first lip 1064 defines a first end face of the base 1000 that includes curved surfaces that define lobes at corners of the first lip 1064 (see also FIG. 2A).

FIG. 2C depicts a side elevation view of the base 1000 of FIG. 2A, looking in a direction 2C from a plane corresponding to line 2C-2C of FIG. 2B. As shown, a through-slot 1015 is defined by an interior surface of the connecting wall 1010, the first arm surface 1022 and first protrusions 1024 of the first arm 1020, and the second arm surface 1032 and second protrusion 1034 of the second arm 1030. In one example, both the first arm surface 1022 and the second arm surface 1032 may be substantially continuous and absent any features (e.g., protrusions) that extend from either surface into the through-slot 1015 defining area. As a result, the case 100 may slide relative to the collar with limited resistance when the collar is positioned by a user within the through-slot 1015 (e.g., by maneuvering the collar around the first protrusions 1024 and the second protrusions 1034 via the gap (G) remaining therebetween shown in FIG. 2B) and the case 100 is moved by the user along a length of the collar. In other examples, the first arm surface 1022 and/or the second arm surface 1032 may include structural features protruding therefrom. In this example, structural features may not protrude from a respective arm surface to the extent that coupling a case according to the present disclosure to a collar would be impeded but may provide some additional resistance to movement of the case relative to the collar.

FIG. 2D depicts a top elevation view of the base 1000 of FIG. 2A, looking in a direction 2D from a plane corresponding to line 2D-2D of FIG. 2C. As shown in FIG. 2D, the connecting wall 1010 extends between the first arm 1020 and the second arm 1030. A first perimeter surface 2014 is defined by surfaces of the connecting wall 1010 and the first arm 1020, and faces the first lip 1064. As shown with a review of FIGS. 2A-2D, the first perimeter surface 2014 extends around the body 1002 providing the base 1000. Similarly, a second perimeter surface 2016 is defined by surfaces of the connecting wall 1010 and the second arm 1030, and faces the second lip 1084. As shown with a review of FIGS. 2B-2E, the second perimeter surface 2016 extends around the body 1002 providing the base 1000. As shown, the second lip 1084 may extend outwardly from the second protruding wall 1082 and defines a second end face of the base 1000.

FIG. 2D also provides a view of the positioning protrusion 2005 that extends between the connecting wall 1010 and the first lip 1064. One of ordinary skill in the art will appreciate that the positioning protrusion 2005, in practice, may help ensure that the first housing 1200 is coupled to the case 100 in the same or similar orientation. That is, the first housing 1200 may not be optimally coupled to the base 1000 unless the positioning protrusion 2005 is received by the notch 1205, as shown in FIG. 4D.

FIG. 2E depicts a front or rear elevation view of the base 1000 of FIG. 2A, looking in a direction 2E from a plane corresponding to line 2E-2E of FIG. 2D. In some examples, the base 1000 may secure the case 100 to the collar such that the second housing 1400 faces toward and/or contacts the pet when the collar is worn by the pet. In such examples, the elevation view of the base 1000 shown in FIG. 2E may be a rear elevation view (e.g., with the second housing 1400 removed to illustrate the second interface 1080 of the base 1000). In other examples, the base 1000 may secure the case 100 to the collar such that the second housing 1400 faces away and/or outwardly from the pet when the collar is worn by the pet. In such examples, the elevation view of the base 1000 shown in FIG. 2A may be a front elevation view (e.g., with the second housing 1400 removed to illustrate the second interface 1080 of the base 1000).

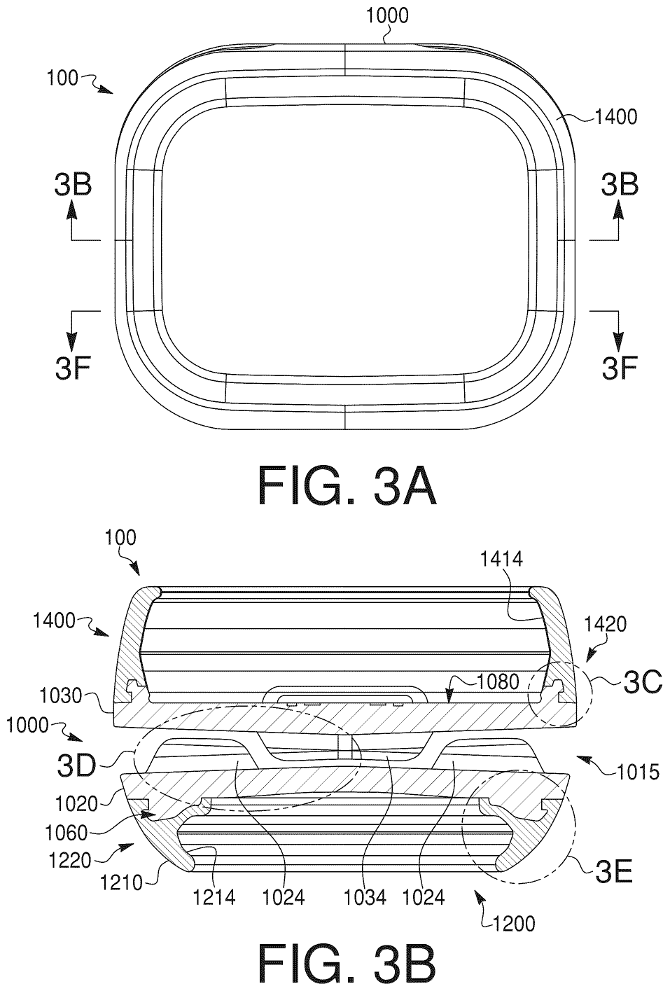

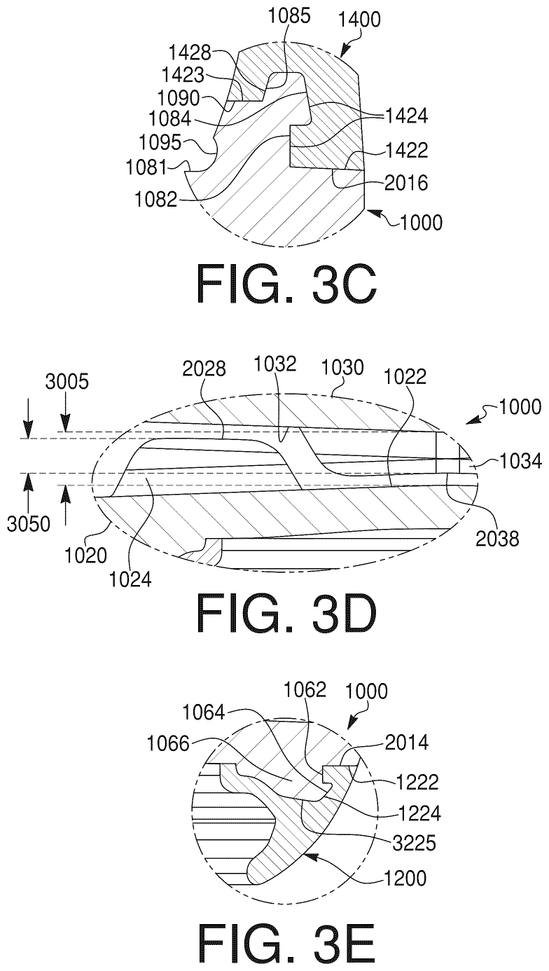

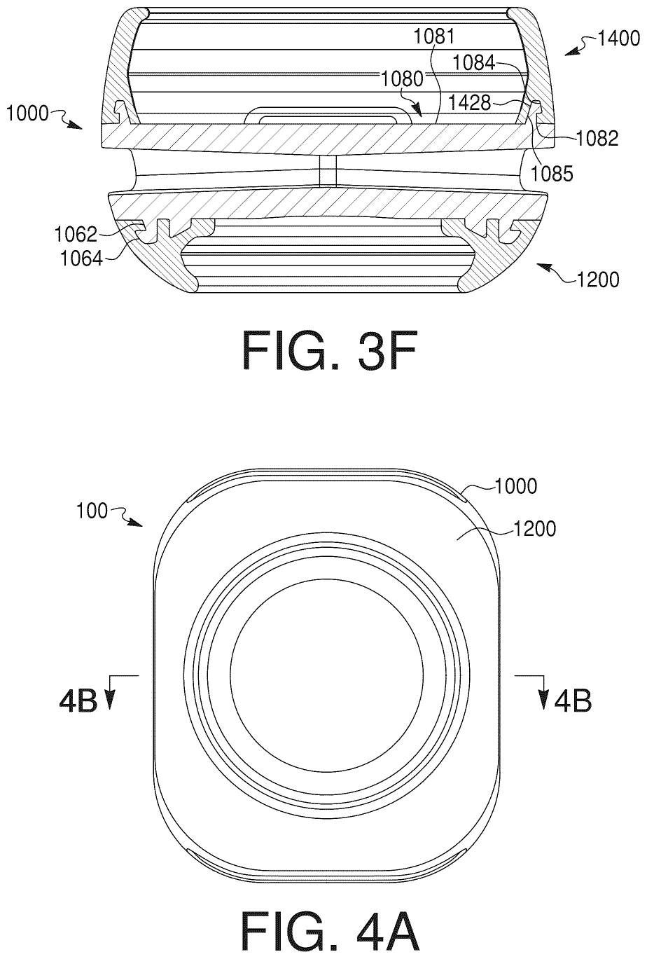

In the example base 1000 illustrated in FIG. 2E, the third protrusions 1090 may extend from the open surface 1081 of the base 1000 and provide one component of the second interface 1080. The second interface 1080 may therefore include the second protruding wall 1082, the second lip 1084, and the third protrusions 1090. In some examples and as shown with reference to FIG. 3C below, the second interface 1080 may also include a second base inner surface 1085. In such examples, the third protrusions 1090 may be disposed adjacent to, but not in strict contact with, the second base inner surface 1085.

With respect to FIGS. 3A-3F, the various views of the case 100 may be based on a position or orientation of the case 100 relative to a collar or other similar object when the base 1000 of the case 100 receives the collar. FIG. 3A depicts a front or rear elevation view of the case 100. In some examples, the base 1000 may secure the case 100 to the collar such that the second housing 1400 faces toward and/or contacts the pet when the collar is worn by the pet. In such examples, the elevation view of the case 100 shown in FIG. 3A may be a rear elevation view. In other examples, the base 1000 may secure the case 100 to the collar such that the second housing 1400 faces away or outwardly from the pet when the collar is worn by the pet. In such examples, the elevation view of the case 100 shown in FIG. 3A may be a front elevation view.

FIG. 3B depicts a cross-sectional view of the case 100 of FIG. 3A, looking in a direction 3B from a plane corresponding to line 3B-3B of FIG. 3A. According to an aspect of the present disclosure, the second housing inner surface 1414 of the second housing 1400 may be concave in shape and have a radius of curvature corresponding to a rounded surface of a particular accessory. FIG. 3B also provides a cross-sectional view of one portion of an engagement between the second interface 1080 of the base 1000 and the second engagement structure 1420 of the second housing 1400.

FIG. 3C provides an enlarged view of the example engagement between the base 1000 and the second housing 1400. As illustrated in FIG. 3C: the second perimeter surface 2016 of the base 1000 engages the third lateral wall 1422 of the second housing 1400; the second protruding wall 1082 and the second lip 1084 of the base 1000 engages the second extension wall 1424 of the second housing 1400; the second base inner surface 1085 of the second protruding wall 1082 for the base 1000 engages the third extension wall 1428 of second housing 1400; and one of the third protrusions 1090 for the base 1000 engages one of the elongated recesses 1423 of the second housing 1400. A cross-sectional view of the engagement feature 1095 defined by the third protrusion 1090 is also illustrated in FIG. 3C.

Turning back to FIG. 3B, as shown, the first protrusions 1024 extend from the first arm 1020 toward the second arm 1030 and spatially overlap with the second protrusion 1034, which extends from the second arm 1030 toward the first arm 1020. FIG. 3D provides a closer view of this overlap. Referring to FIGS. 3B and 3D concurrently, the first protrusions 1024 may spatially overlap with the second protrusion 1034 by an overlap distance 3050 between a surface of the first planar wall 2028 of each of the first protrusions 1024 and a surface of the second planar wall 2038 of the second protrusion 1034. After a user maneuvers or otherwise manipulates an object, such as a collar, into the through-slot 1015 via the gap (FIG. 2B) remaining between the first arm 1020 and the second arm 1030 (e.g., by maneuvering the collar around the first protrusions 1024 and the second protrusion 1034), the overlap distance 3050 may be configured to help ensure the object cannot fall or otherwise slip out of the case 100 until the collar is again intentionally maneuvered or manipulated by the user out of the through-slot 1015. Accordingly, the overlap distance 3050 may be less than a height 3005 of the through-slot 1015 (FIG. 3B) between the first arm surface 1022 and the second arm surface 1032. In one example range for the overlap distance 3050 may be 2.5 to 3.0 mm.

Returning to FIG. 3B, according to an aspect of the present disclosure, the first housing inner surface 1214 of the first outer wall 1210 may be concave in shape and have a first radius of curvature that corresponds to a rounded surface of a particular accessory. However, in other examples, the first housing inner surface 1214 may have different shapes to accommodate alternative shapes and sizes of accessories. FIG. 3B also provides a cross-sectional view of one portion of an engagement between the first interface 1060 of the base 1000, and the first engagement structure 1220 of the first housing 1200.

FIG. 3E provides an enlarged view of the example engagement between the base 1000 and the first housing 1200. As illustrated in FIG. 3E: the first perimeter surface 2014 of the base 1000 engages the first lateral wall 1222 of the first housing 1200; the first protruding wall 1062 and the first lip 1064 of the base 1000 engage the first extension wall 1224 of the first housing 1200; and one of the ribs 1066 of the base 1000 engages a slot wall 3225 that defines one of the engagement slots 1225 (FIG. 1C) of the first housing 1200.

FIG. 3F depicts a cross-sectional view of the case of FIG. 3A, looking in a direction 3F from a plane corresponding to line 3F-3F of FIG. 3A. Unlike in FIG. 3B, since there is no third protrusion 1090 based on the different cross-sectional plane, the second base inner surface 1085 of the second interface 1080 engages the third extension wall 1428 of the second housing 1400 from an end face defined by the second protruding wall 1082 and the second lip 1084 to the open surface 1081 of the base 1000. Likewise, with respect to the first housing 1200, a portion of the first base inner surface 1065 (FIG. 1D) of the first protruding wall 1062 provided between two of the ribs 1066 may engage a vertical wall of the first housing 1200 extending between a respective pair of engagement slots 1225 (not shown).

As illustrated in FIGS. 3B, 3C, 3E, and 3F, the first interface 1060 and the second interface 1080 of the base 1000 include protruding walls and lips extending from the protruding walls. In addition, the first interface 1060 and the second interface 1080 are illustrated as having ribs and/or protrusions disposed inwardly of protruding walls. However, example bases according to the present disclosure are not limited to the structural configurations described herein. For example, first and second interfaces for bases of the present disclosure may include: multiple protruding walls; multiple lips formed on a protruding wall; a protruding wall provided in sections, each section defining a prong; an unevenly distributed number of ribs; and/or interlocking protrusions of different shapes. In addition, example housings as described herein may include extension walls and/or define slots, combinations thereof, and/or other structural features configured to correspond to structural configurations of interfaces.

More generally, cases according to the present disclosure include bases and housings that may have features that respectively provide interfaces and engagement structures corresponding to the interfaces. Furthermore, example engagement structures may be friction fitted, or employ another mechanical fitting technique (e.g., snap fit), onto example interfaces and provide a secure coupling between respective housings and bases. In particular, couplings provided between example bases and housings according to the present disclosure are configured to couple accessories to example cases such that accessories accommodated within the housings remain securely coupled to the cases being coupled to collars worn by pets. At the same time, such accessories may be intentionally removed from the cases without unduly complex or user strain-inducing processes.

FIG. 4A depicts a front or rear elevation view of the case 100. In some examples, the base 1000 may secure the case 100 to the collar such that the first housing 1200 faces away or outwardly from the pet when the collar is worn by the pet. In such examples, the elevation view of the case 100 shown in FIG. 4A may be a front elevation view. In other examples, the base 1000 may secure the case 100 to the collar such that the first housing 1200 faces toward or contacts the pet when the collar is worn by the pet. In such examples, the elevation view of the case 100 shown in FIG. 4A may be a rear elevation view.

FIG. 4B depicts a cross-sectional view the case 100 of FIG. 4A, looking in a direction 4B from a plane corresponding to line 4B-4B of FIG. 4A. More particularly, FIG. 4B illustrates a cross section of the case 100 from a plane disposed along a longitudinal axis of the case 100 in a location corresponding to line 4B-4B. Accordingly, FIG. 4B illustrates one portion of respective engagements between the first interface 1060 of the base 1000 and the first engagement structure 1220 of the first housing 1200, and the second interface 1080 of the base 1000 and the second engagement structure 1420 of the second housing 1400.

FIG. 4C provides an enlarged view of the example engagement between the base 1000 and the first housing 1200. As illustrated in FIG. 4C: the first perimeter surface 2014 of the base 1000 engages the first lateral wall 1222 of the first housing 1200; the first protruding wall 1062 and the first lip 1064 of the base 1000 engage the first extension wall 1224 of the first housing 1200; and the first base inner surface 1065 provided by the first protruding wall 1062 is provided between two of the ribs 1066 and engages one of the vertical walls of the first housing 1200 extending between a respective pair of engagement slots 1225 (not shown).

FIG. 4D also provides an enlarged view of a portion of the example engagement between the base 1000 and the first housing 1200 that includes the positioning protrusion 2005 engaged with the notch 1205 of the first housing 1200.

In some examples, the case 100 and/or components thereof described with reference to FIGS. 1A-4D may be used to secure one or more accessories to a pet's collar. To provide an example use case, a user (e.g., a pet owner) may attach the case 100 to the collar via the base 1000. For example, a user may maneuver or otherwise manipulate the collar into the through-slot 1015 via the gap that remains between the first arm 1020 and the second arm 1030 (e.g., may maneuver or manipulated the collar around the first protrusions 1024 and the second protrusion 1034 into the through-slot 1015). Once the collar is positioned with the through-slot 1015, the overlap distance 3050 of the first protrusions 1024 and the second protrusion 1034 may help prevent the collar from slipping out or otherwise becoming detached from the case 100, even when the pet is highly active, until the collar is again intentionally maneuvered or manipulated by the user out of the through-slot 1015 via the gap.

Before or after the case 100 is attached to the collar via the base 1000, the user may insert an accessory into one or more of the first housing 1200 and the second housing 1400. As one non-limiting example, a location tracker may be inserted into first housing 1200 and an activity tracker may be inserted into the second housing 1400. As described in detail above, the first housing 1200 and the second housing 1400 are configured to securely couple the accessories to the case 100, such that when the case 100 is securely attached to the collar via the base 1000, and the collar is fastened to the pet, the accessories will remain within a proximity of the pet to enable intended functionality (e.g., tracking location and/or activity of the pet). The accessories may be removable from the first housing 1200 and/or second housing 1400 at any time (e.g., including when the case 100 is attached to the collar) to enable charging or interchanging/replacement of the accessories, for example.

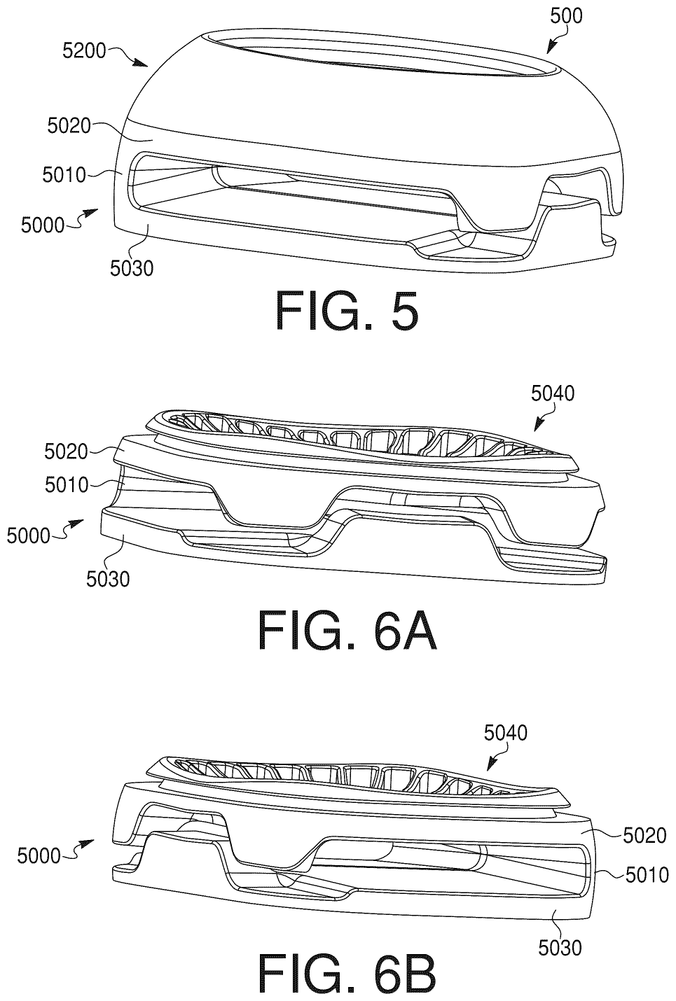

FIG. 5 depicts a side perspective view of a case 500, according to an aspect of the present disclosure. The case 500 of FIG. 5 may be substantially similar to other cases described herein, such as the case 100. For example, the case 500 includes a base 5000 and a housing 5200 similar to the base 1000 and the first housing 1200 of the case 100. FIGS. 6A and 6B depict front and side perspective views of the base 5000 of the case 500, according to an aspect of the present disclosure. As shown in FIGS. 5, 6A and 6B, the base 5000 includes a connecting wall 5010 having a first end and a second end, a first arm 5020 extending from the first end of the connecting wall 5010, and a second arm 5030 extending from the second end of the connecting wall 5010. As shown in FIGS. 6A and 6B, with respect to the first arm 5020, an interface 5040, similar to the first interface 1060 of the base 1000 of the case 100, extends from the first arm 5020. The interface 5040 is configured to receive an engagement structure of the housing 5200. The engagement structure of the housing 5200 may be similar to the first engagement structure 1220 of the first housing 1200, described above.

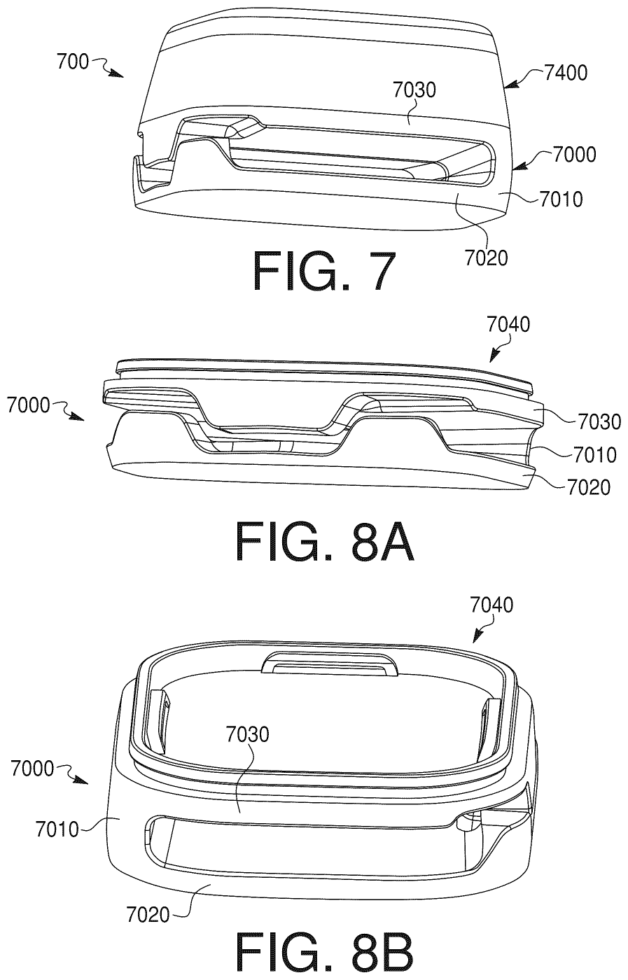

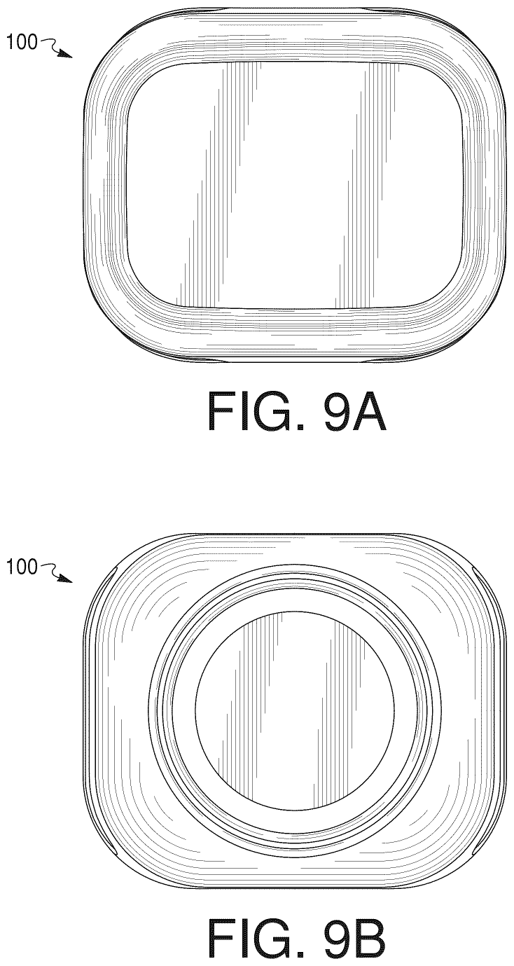

FIG. 7 depicts a side perspective view of a case 700, according to an aspect of the present disclosure. The case 700 of FIG. 7 may be substantially similar to other cases described herein, such as the case 100. For example, the case 700 includes a base 7000 and a housing 7400 similar to the base 1000 and the second housing 1400 of the case 100. FIGS. 8A and 8B depict front and side perspective views of the base 7000 of the case 700, according to an aspect of the present disclosure. As shown in FIGS. 7, 8A, and 8B, the base 7000 includes a connecting wall 7010 having a first end and a second end, a first arm 7020 extending form the first end of the connecting wall 7010, and a second arm 7030 extending from the second end of the connecting wall 7010. As shown in FIGS. 8A and 8B, with respect to the second arm 7030, an interface 7040, similar to the second interface 1080 of the base 1000 of the case 100, extends from the second arm 7030. The interface 7040 is configured to receive an engagement structure of the housing 7400. The engagement structure of the housing 7400 may be similar to the second engagement structure 1420 of the second housing 1400 described above.

In some examples, configurations for a case according to the present disclosure may include a base that includes an interface similar to the first interface 1060 extending from each of first and second arms of the base. Another configuration may include an interface similar to the second interface 1080 extending from one of the first or second arms of a base, and another interface similar to the first interface 1060 extending from the other of the first or second arms of the base. Still further, cases according to the present disclosure may include a base that includes an interface similar to the second interface 1080 extending from each of first and second arms of the base.

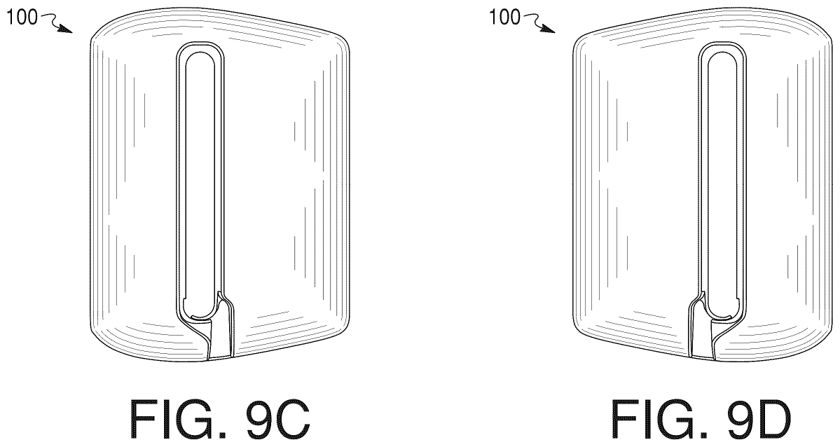

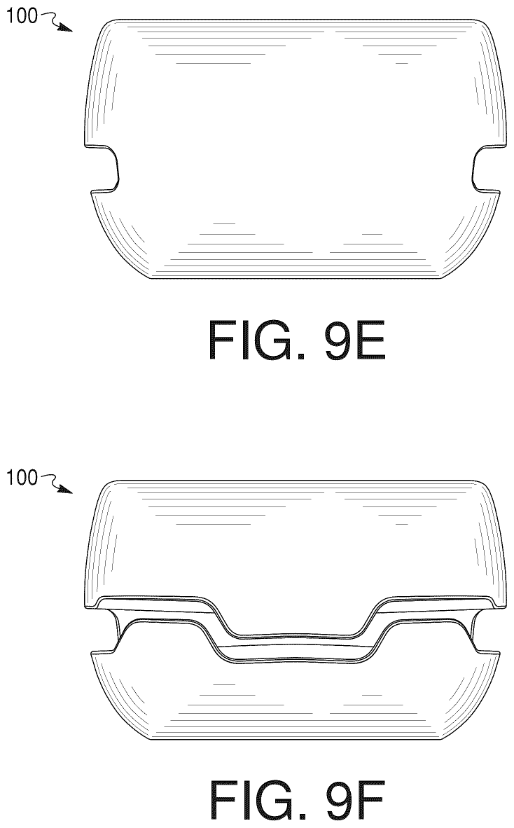

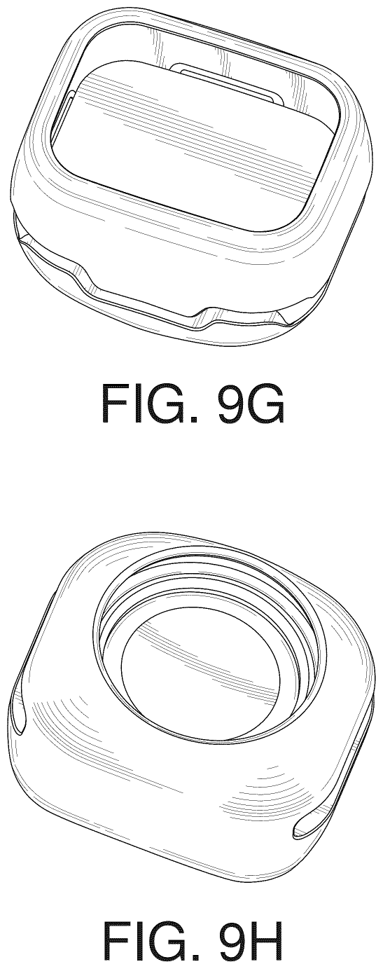

The case 100 may be secured to a collar of a pet in various different orientations. FIGS. 9A-9F illustrate elevated views of the case 100 when the case 100 is secured to the collar in a first orientation. For example, FIG. 9A depicts a front elevated view of the case 100 that faces away or outwardly from the pet when the collar is worn by the pet and is most visible to the user. FIG. 9B depicts a rear elevated view of case 100 that faces towards and/or contacts the pet when the collar is worn by the pet. However, when the case 100 is secured to the collar in an alternative orientation, FIG. 9A may instead depict the rear elevated view, while FIG. 9B depicts the front elevated view. Continuing with the example of when the case 100 is secured to the collar in the first orientation, FIG. 9C depicts the left side elevated view of the case, and FIG. 9D depicts the right side elevated view of the case 100. These views may be reversed when the case 100 is secured to the collar in the alternative orientation. In either the first or alternative orientation, FIG. 9E depicts a top elevated view of case 100, and FIG. 9F depicts a bottom elevated view of the case 100, when the collar is maneuvered or otherwise manipulated into the case 100 via the bottom of the case 100. However, in other examples, the collar may be maneuvered or otherwise manipulated into the case 100 via the top of the case 100, and in such examples, FIG. 9E may instead depict the bottom elevated view, while FIG. 9F depicts the top elevated view.

FIGS. 9G and 9H illustrate perspective views of the case 100 when the case 100 is secured to the collar in the first orientation. For example, FIG. 9G depicts a front perspective view of the case 100, and FIG. 9H depicts a rear perspective view of case 100 when the case 100 is secured to the collar in the first orientation. However, when the case 100 is secured to the collar in the alternative orientation, FIG. 9G may instead depict the rear perspective view, while FIG. 9H depicts the front perspective view.

While some examples described herein include some but not other features included in other examples, combinations of features of different examples are meant to be within the scope of the invention, and form different examples, as would be understood by those skilled in the art. Thus, while certain examples have been described, those skilled in the art will recognize that other and further modifications may be made thereto without departing from the spirit of the invention, and it is intended to claim all such changes and modifications as falling within the scope of the invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A base having a body that defines:
a connecting wall having a first end and a second end;
a first arm extending from the first end of the connecting wall, the first arm including a first surface and a first protrusion extending from the first surface;
a second arm extending from the second end of the connecting wall, the second arm including a second surface and a second protrusion extending from the second surface toward the first arm, wherein the second protrusion overlaps with the first protrusion to retain a collar received in a through-slot defined by the connecting wall, the first and second surfaces, and the first and second protrusions; and
a first interface extending from the first arm opposite a side of the first arm including the first surface, wherein the first interface is configured to couple a housing to the base.

2. The base of claim 1, wherein the first interface includes a first protruding wall extending from the first arm and a first lip extending outwardly from the first protruding wall.

3. The base of claim 1, wherein the second protrusion overlaps the first protrusion over a first distance, the first distance being less than a height of the through-slot between the first surface and the second surface.

4. The base of claim 3, wherein the first distance is in a range of 2.5 mm to 3.0 mm.

5. The base of claim 1, wherein the first protrusion includes a pair of spaced apart first protrusions, and the second protrusion partially extends into a recess defined by the pair of spaced apart first protrusions.

6. The base of claim 1, wherein the first interface includes:
a first protruding wall extending from the first arm;
a first lip extending outwardly from the first protruding wall; and
a plurality of ribs extending inwardly from the first protruding wall.

7. The base of claim 1, where the body of the base further defines a second interface extending from the second arm opposite a side of the second arm including the second surface, wherein the second interface is configured to couple another housing to the base.

8. The base of claim 7, wherein the second interface includes:
a second protruding wall extending from the second arm;
a second lip extending outwardly from the second protruding wall; and
one or more protrusions disposed inwardly of the second protruding wall.

9. A case comprising:
a base having a body that defines:
a connecting wall having a first end and a second end;
a first arm extending from the first end of the connecting wall, the first arm including a first surface and a first protrusion extending from the first surface;
a second arm extending from the second end of the connecting wall, the second arm including a second surface and a second protrusion extending from the second surface toward the first arm such that a through-slot for receiving a collar is defined by the connecting wall, the first and second surfaces, and the first and second protrusions;
a protruding wall extending from the first arm opposite a side of the first arm including the first surface; and
a lip extending outwardly from the protruding wall; and
a housing coupled to the base, wherein a structure of the housing defines:
an outer wall extending from a first end to a second end of the housing;
a first lateral wall at the first end of the housing extending inwardly from the outer wall; and
an extension wall extending from the first lateral wall toward the second end of the housing and defining a portion of an engagement structure of the housing, wherein the extension wall engages with the protruding wall and the lip of the base to couple the housing to the base.

10. The case of claim 9, wherein the structure of the housing further defines a second lateral wall that is surrounded by the first lateral wall, and wherein the second lateral wall defines an aperture of the housing and a plurality of slots disposed radially between the extension wall and the aperture.

11. The case of claim 10, wherein the body of the base further defines a plurality of ribs extending inwardly from the protruding wall, wherein the plurality of ribs are received in the plurality of slots.

12. The case of claim 9, wherein the body of the base further defines one or more protrusions disposed inwardly of the protruding wall, and the structure of the housing further defines another extension wall disposed inwardly of the extension wall, the other extension wall including a plurality of elongated recesses configured to correspond to the one or more protrusions as another portion of the engagement structure of the housing.

13. The case of claim 9, wherein the housing is formed from a flexibly elastic material, the outer wall includes an inner surface that extends between a first aperture defined at the first end of the housing and a second aperture defined at the second end of the housing, and the inner surface of the outer wall is configured to elastically deform around an outer surface of an accessory to be received by the housing to couple the accessory to the base.

14. The case of claim 9, wherein the base is formed from a rigid first material, and wherein the housing is formed from a flexibly elastic second material.

15. A case comprising:
a base having a body that defines:
a connecting wall having a first end and a second end;
a first arm extending from the first end of the connecting wall, the first arm including a first surface and at least one first protrusion extending from the first surface;
a second arm extending from the second end of the connecting wall, the second arm including a second surface and at least one second protrusion extending from the second surface toward the first arm such that a through-slot for receiving a collar is defined by the connecting wall, the first and second surfaces, and the first and second protrusions;
a first interface extending from the first arm opposite a side of the first arm including the first surface; and
a second interface extending from the second arm opposite a side of the second arm including the second surface;
a first housing coupled to the base via the first interface and configured to receive a first accessory; and
a second housing coupled to the base via the second interface and configured to receive a second accessory different than the first accessory.

16. The case of claim 15, wherein the first interface includes a first protruding wall extending from the first arm, a first lip extending outwardly from the first protruding wall, and a plurality of ribs extending inwardly from the first protruding wall.

17. The case of claim 16, wherein the first housing includes a first engagement structure corresponding to the first interface to couple the first housing to the base, the first engagement structure including a plurality of slots configured to receive the plurality of ribs.

18. The case of claim 15, wherein the second interface includes a second protruding wall extending from the second arm, a second lip extending outwardly from the second protruding wall, and one or more protrusions disposed inwardly of the second protruding wall.

19. The case of claim 18, wherein the second housing includes a second engagement structure corresponding to the second interface to couple the second housing to the base, the second engagement structure including one or more elongated recesses configured to correspond to the one or more protrusions.

20. The case of claim 15, wherein the base is formed from a rigid first material, and wherein the first housing and the second housing are formed from a flexibly elastic second material.
